(19) United States
(12) Patent Application Publication
(10) Pub. No.: US 2012/0236402 A1
(43) Pub. Date: Sep. 20, 2012

(54) DISPLAY DEVICE

(75) Inventor: Tsuyoshi Ohyama, Tokyo (JP)

(73) Assignee: Sony Corporation, Tokyo (JP)

(21) Appl. No.: 13/408,608

(22) Filed: Feb. 29, 2012

(30) Foreign Application Priority Data
Mar. 15, 2011 (JP) 2011-056993

(51) Int. Cl. G02B 27/22

(52) U.S. Cl. 359/462

(57) ABSTRACT

A display device includes: a display unit having a region which emits color light for displaying a stereoscopic image including images of a plurality of viewing points; and a separation unit that separates optically the images of the respective viewing points from each other so that the images of different viewing points are observed by different eyes of a viewer, wherein in a visible region on the display unit in which the image of a predetermined viewing point observed by the viewer is displayed, the region which emits the color light is present at each position of the stereoscopic image in a parallax direction regardless of a viewing position of the viewer who observes the stereoscopic image.

### FIELD

The present disclosure relates to a display device and in particular, to a display device capable of suppressing the generation of a moiré.

### BACKGROUND

In the related art, display devices which display a stereoscopic image without the help of special glasses using a parallax barrier method, a lenticular lens method, and the like are known.

In such display devices, image display is performed such that images with different viewing points are observed by the different eyes of each viewer. In such display devices, however, since a pixel region of the display device where an image is displayed and a non-pixel region of the display device where an image is not displayed are perceived by the viewer, a moiré is generated. That is, the moiré is generated when the brightness difference between the pixel region and the non-pixel region is large.

For this reason, a technique for reducing the moiré has been proposed in which when displaying a stereoscopic image using a parallax barrier, a slit region of the parallax barrier is formed in the shape of a parallelogram in order to smooth a change in the brightness perceived by the viewer (for example, refer to JP-A-2005-86506).

### SUMMARY

However, although it is possible to reduce the moiré to some extent in the technique described above, crosstalk occurs in proportion to the moiré reduction. As a result, the visibility as 3D is significantly lowered.

It is therefore desirable to suppress the generation of a moiré.

An embodiment of the present disclosure is directed to a display device including: a display unit having a region which emits color light for displaying a stereoscopic image including images of a plurality of viewing points; and a separation unit that separates optically the images of the respective viewing points from each other so that the images of different viewing points are observed by the different eyes of a viewer. In a visible region on the display unit in which the image of a predetermined viewing point observed by the viewer is displayed, the region which emits the color light is present at each position of the stereoscopic image in a parallax direction regardless of a viewing position of the viewer who observes the stereoscopic image.

The display unit may have not only the region which emits the color light but also a light shielding region which blocks light. At each position in the parallax direction in the visible region, the total width of the light shielding region in a vertical direction approximately perpendicular to the parallax direction may be set as an approximately fixed value.

The display unit may have not only the region which emits the color light but also a light shielding region which blocks light. The area of the light shielding region in the visible region may be set as an approximately fixed value regardless of the viewing position of the viewer who observes the stereoscopic image.

The display unit may have not only the region which emits the color light but also a light shielding region which blocks light. The region which emits the color light may be formed by providing a light shielding section, which becomes the light shielding region, in a part of a filter through which the color light is transmitted. The light shielding section may be provided at both edge sides of the filter in a vertical direction approximately perpendicular to the parallax direction.

In the embodiment of the present disclosure, the images of the respective viewing points are displayed on the display unit having a region which emits color light for displaying a stereoscopic image including images of a plurality of viewing points, and the images of the respective viewing points are optically separated from each other by the separation unit so that the images of different viewing points are observed by the different eyes of a viewer. In addition, in the visible region on the display unit in which the image of a predetermined viewing point observed by the viewer is displayed, the region which emits the color light is present at each position of the stereoscopic image in the parallax direction regardless of the viewing position of the viewer who observes the stereoscopic image.

Another embodiment of the present disclosure is directed to a display device including: a display unit having a region which emits color light including a plurality of viewing point images; and a separation unit that separates optically the viewing point images from each other. The display unit has not only the region which emits the color light but also a light shielding region which blocks light. The total width of the light shielding region in a vertical direction approximately perpendicular to a direction in which the viewing point images are aligned is an approximately fixed value.

In the embodiment of the present disclosure, respective viewing point images are displayed on the display unit having a region which emits color light including a plurality of viewing point images, and the respective viewing point images are optically separated from each other by the separation unit. In addition, the display unit includes not only the region which emits the color light but also the light shielding region which blocks light, and the total width of the light shielding region in a vertical direction approximately perpendicular to a direction in which the viewing point images are aligned is set as an approximately fixed value.

According to the embodiments of the present disclosure, it is possible to suppress the generation of a moiré.

### BRIEF DESCRIPTION OF THE DRAWINGS

FIG. 1 is a view showing an example of the configuration of a stereoscopic image display device according to an embodiment;

FIG. 2 is a view showing an example of the configuration of a display unit;

FIG. 3 is a view showing an example of a stereoscopic image;

FIG. 4 is a view showing an example of the arrangement of color filters;

FIG. 5 is a view explaining the aperture ratio of a filter region in a visible region;

FIG. 6 is a view showing an example of the arrangement of color filters;

FIG. 7 is a view showing an example of the arrangement of color filters; and

FIG. 8 is a view showing an example of the arrangement of color filters.

### DETAILED DESCRIPTION

Hereinafter, embodiments of the present disclosure will be described with reference to the accompanying drawings.

### First Embodiment

### Example of the Configuration of a Stereoscopic Image Display Device

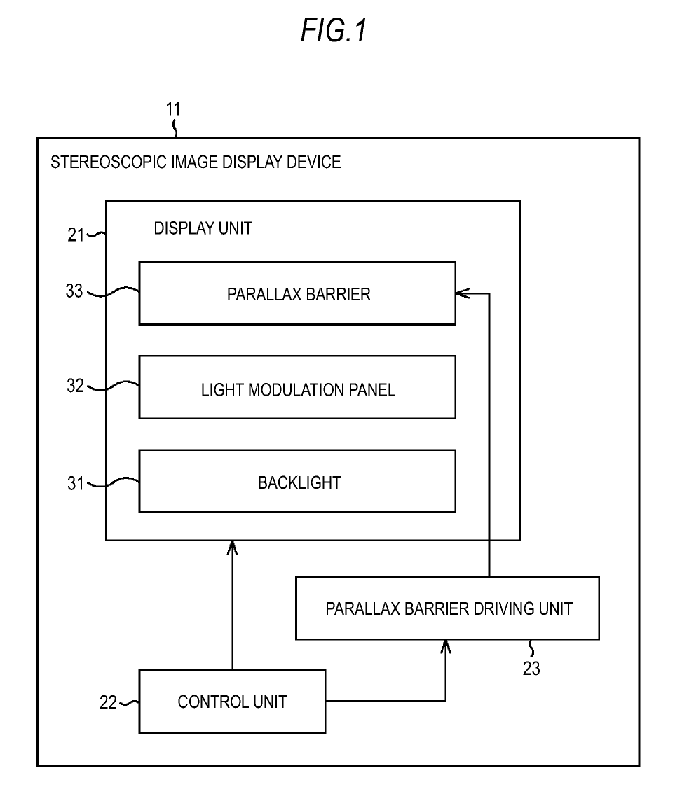

FIG. 1 is a view showing an example of the configuration of a stereoscopic image display device according to an embodiment of the present disclosure.

A stereoscopic image display device 11 displays a stereoscopic image and a planar image while performing display switching between a three-dimensional stereoscopic image based on a parallax barrier method and a two-dimensional planar image according to necessity. The stereoscopic image display device 11 is configured to include a display unit 21, a control unit 22, and a parallax barrier driving unit 23.

The display unit 21 includes a backlight 31, a light modulation panel 32, and a parallax barrier 33, and displays a two-dimensional planar image or a three-dimensional stereoscopic image including an image for the right eye observed (perceived) by the right eye of a viewer and an image for the left eye observed by the left eye of the viewer.

That is, the backlight 31 is an illumination device for only an image display which includes a light guide plate, a light source such as an LED (Light Emitting Diode), and a reflecting sheet. The backlight 31 emits light for displaying an image so that the light is incident on the light modulation panel 32.

The light modulation panel 32 is a liquid crystal display panel including a color filter of each color of R, G, and B, a liquid crystal layer, a polarizing plate, and a thin film transistor. The light modulation panel 32 allows light incident from the backlight 31 to be transmitted therethrough in order to display an image. In this case, the light modulation panel 32 performs gray-scale display of each pixel of an image by changing the transmittance of light for each pixel provided in the light modulation panel 32.

The parallax barrier 33 includes a polarizing plate, a switch liquid crystal layer, and the like. At the time of display of a stereoscopic image, the parallax barrier 33 separates optically an image for the right eye from an image for the left eye by blocking some of light beams incident from the light modulation panel 32 and allowing the remaining light beams to be transmitted therethrough. In addition, the parallax barrier 33 allows light incident from the light modulation panel 32 to be transmitted therethrough as it is at the time of display of a planar image.

The control unit 22 controls each unit of the stereoscopic image display device 11, that is, the display unit 21 or the parallax barrier driving unit 23. For example, the control unit 22 drives a display driver (not shown) of the display unit 21 to display an image on the light modulation panel 32 or to emit light from the backlight 31.

The parallax barrier driving unit 23 drives the parallax barrier 33 according to the control of the control unit 22 to block some of light beams, which are incident on the parallax barrier 33 from the light modulation panel 32, so that an image for the right eye and an image for the left eye are separated from each other. More specifically, the parallax barrier driving unit 23 forms a slit region, through which light is transmitted, and a light shielding region, which is for blocking light, in the parallax barrier 33.

### [Example of the Configuration of a Display Unit]

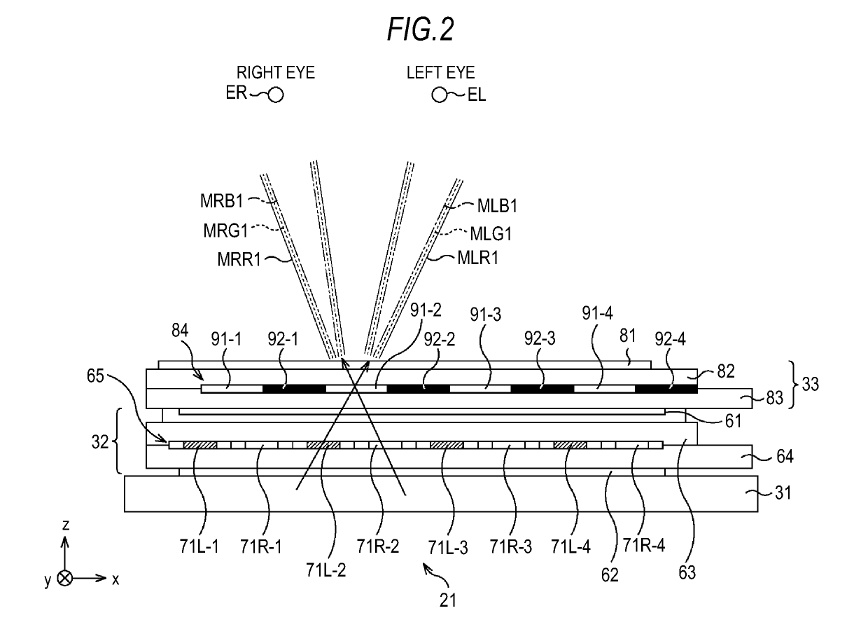

Next, the configuration of the display unit 21 shown in FIG. 1 will be described. FIG. 2 is a view showing an example of the more detailed configuration of the display unit 21. In addition, sections in FIG. 2 corresponding to the sections in FIG. 1 are denoted by the same reference numerals, and the explanation will be appropriately omitted. Moreover, in FIG. 2, the horizontal direction, the depth direction, and the vertical direction are assumed to be x, y, and z directions, respectively.

In FIG. 2, the light modulation panel 32 includes polarizing plates 61 and 62, a counter substrate 63, a TFT (Thin Film Transistor) substrate 64, and a liquid crystal layer 65.

That is, the plate-shaped counter substrate 63 and the plate-shaped TFT substrate 64 are provided so as to face each other between the polarizing plates 61 and 62 disposed so as to face each other. Then, the liquid crystal layer 65 is formed between the counter substrate 63 and the TFT substrate 64.

On a surface of the counter substrate 63 facing the liquid crystal layer 65, a color filter or a counter electrode is provided for each pixel. In particular, a color filter of each color of R, G, and B is provided in a region of each pixel of the counter substrate 63. In addition, on a surface of TFT substrate 64 facing the liquid crystal layer 65, a TFT (thin film transistor) which is a pixel electrode or a driving element is provided for each pixel.

Light transmissive sections 71L-1 to 71L-4, which allow light for displaying an image for the left eye to be transmitted therethrough at the time of display of a stereoscopic image, and light transmissive sections 71R-1 to 71R-4, which allow light for displaying an image for the right eye to be transmitted therethrough at the time of display of a stereoscopic image, are provided in the liquid crystal layer 65. In the light modulation panel 32, one light transmissive section is provided for each pixel arrayed in a matrix.

When a voltage is applied to the counter electrode of the counter substrate 63 and the pixel electrode of the TFT substrate 64 at the time of display of a stereoscopic image or a planar image, the orientation direction of liquid crystal molecules sealed in the light transmissive sections 71L-1 to 71R-4 changes according to the size of the voltage. As a result, since the transmittance of light incident on the light modulation panel 32 from the backlight 31 changes, the amount of light transmitted through each pixel becomes the amount of light corresponding to the pixel value of an image displayed on these pixels.

In addition, hereinafter, the light transmissive sections 71L-1 to 71L-4 are also simply called a light transmissive section 71L when it is not necessary to distinguish the light transmissive sections 71L-1 to 71L-4, and the light transmissive sections 71R-1 to 71R-4 are also simply called a light transmissive section 71R when it is not necessary to distinguish the light transmissive sections 71R-1 to 71R-4. In addition, the light transmissive sections 71L and 71R are also simply called a light transmissive section 71 hereinafter when it is not necessary to distinguish the light transmissive sections 71L and 71R in particular.

In the light modulation panel 32, the light transmissive sections 71L and 71R are alternately provided in the x direction on the xy plane, and the light transmissive sections 71L or 71R are arrayed continuously in the y direction.

Accordingly, at the time of display of a stereoscopic image, a rectangular region on an image for the left eye which forms the stereoscopic image and a rectangular region on an image for the right eye which forms the stereoscopic image are alternately arrayed in the x direction and displayed on the light modulation panel 32. In addition, light transmitted through one pixel, that is, one light transmissive section 71, becomes light which displays one pixel on an image.

Here, although the image for the left eye and the image for the right eye which form the stereoscopic image are images with parallax, the x direction in FIG. 2 is a direction of the parallax between the image for the left eye and the image for the right eye, that is, a direction in which the left and right eyes of the viewer are arrayed. The x direction is also called a parallax direction hereinbelow.

In addition, at the time of display of a two-dimensional planar image, each light transmissive section 71 makes light, which is for displaying a planar image and is incident from the backlight 31, transmitted therethrough and incident on the parallax barrier 33.

The parallax barrier 33 is configured to include polarizing plates 61 and 81, transparent plates 82 and 83, and a switch liquid crystal layer 84. In FIG. 2, the polarizing plate 61 is used as both a member which forms the light modulation panel 32 and a member which forms the parallax barrier 33.

In the parallax barrier 33, the plate-shaped transparent plates 82 and 83 are provided so as to face each other between the polarizing plates 61 and 81 disposed so as to face each other. In addition, the switch liquid crystal layer 84 is formed between the transparent plates 82 and 83.

Electrodes are formed on surfaces of the transparent plates 82 and 83 facing the switch liquid crystal layer 84, and the orientation direction of liquid crystal molecules in the switch liquid crystal layer 84 changes when a voltage is applied to some or all of these electrodes. As a result, a parallax barrier is formed in the switch liquid crystal layer 84.

In the example shown in FIG. 2, a parallax barrier formed by slit regions 91-1 to 91-4, which allow light incident from the light modulation panel 32 to be transmitted therethrough, and light shielding regions 92-1 to 92-4, which block light incident from the light modulation panel 32, is formed in the switch liquid crystal layer 84.

In addition, hereinafter, the slit regions 91-1 to 91-4 are also simply called a slit region 91 when it is not necessary to distinguish the slit regions 91-1 to 91-4, and the light shielding regions 92-1 to 92-4 are also simply called a light shielding region 92 when it is not necessary to distinguish the light shielding regions 92-1 to 92-4.

In FIG. 2, the slit region 91 and the light shielding region 92, each of which has a rectangular shape that is long in the y direction, are alternately formed in the parallax direction (x direction) in the switch liquid crystal layer 84. That is, the striped parallax barrier is formed in the switch liquid crystal layer 84. Here, the region where the light shielding region 92 is formed is a region to which a voltage is applied by the electrode.

In the display unit 21, a voltage is applied to electrodes of the transparent plates 82 and 83 at the time of display of a stereoscopic image. Then, a parallax barrier shown in FIG. 2 is formed in the switch liquid crystal layer 84. In such a case, a light beam incident on the slit region 91, among light beams which are emitted from the light modulation panel 32 to become linearly polarized light beams by the polarizing plate 61, is transmitted as it is through the slit region 91 and the polarizing plate 81. On the other hand, a light beam incident on the light shielding region 92, among light beams which are emitted from the light modulation panel 32 to become linearly polarized light beams by the polarizing plate 61, is absorbed in the light shielding region 92 so as not to be emitted from the parallax barrier 33.

Moreover, in the display unit 21, a parallax barrier is not formed in the switch liquid crystal layer 84 at the time of display of a planar image since a voltage is not applied to the electrodes of the transparent plates 82 and 83. That is, the entire region of the switch liquid crystal layer 84 is the same as a slit region. In this case, all light beams incident from the light modulation panel 32 are transmitted through the parallax barrier 33 and are then incident on the left and right eyes of the viewer.

### [Explanation Regarding an Operation of a Stereoscopic Image Display Device]

Next, an operation of the stereoscopic image display device 11 will be described. Moreover, as shown in FIG. 2, the viewer observes an image displayed on the stereoscopic image display device 11 from the position which is separated by a predetermined distance (for example, 30 cm) in the z direction from the surface of the parallax barrier 33 of the display unit 21. In addition, the distance between the right eye ER and the left eye EL of a general viewer is about 6.5 cm.

First, a case where a stereoscopic image is displayed will be described. In such a case, the control unit 22 applies a voltage to a counter electrode of the counter substrate 63 and a pixel electrode of the TFT substrate 64 for each pixel of the light modulation panel 32 on the basis of an image signal of a stereoscopic image. Then, the light transmissive section 71 which displays each pixel of the stereoscopic image allows light to be transmitted therethrough at the light transmission rate corresponding to the pixel values of these pixels.

In addition, the control unit 22 instructs the parallax barrier driving unit 23 to drive the parallax barrier 33, and the parallax barrier driving unit 23 drives the parallax barrier 33 in response to the instruction. That is, the parallax barrier driving unit 23 applies a voltage to electrodes of the transparent plates 82 and 83 so that the parallax barrier formed by the slit regions 91 and 92 is formed in the switch liquid crystal layer 84.

In addition, the control unit 22 makes light be emitted from the backlight 31. The light emitted from the backlight 31 is transmitted through the polarizing plate 62 and the TFT substrate 64 and is then incident on the light transmissive section 71. Then, the light incident on the light transmissive section 71 is transmitted through the light transmissive section 71 at the light transmission rate corresponding to the pixel value of each pixel of the stereoscopic image and is then incident on the eyes of the viewer through the counter substrate 63, the polarizing plate 61, the transparent plate 83, the slit region 91, the transparent plate 82, and the polarizing plate 81.

In this case, a light beam transmitted through the light transmissive section 71L for the left eye among light beams emitted from the backlight 31 is incident on the left eye EL of the viewer, and a light beam transmitted through the light transmissive section 71R for the right eye is incident on the right eye ER of the viewer. Then, the image for the left eye and the image for the right eye which form the stereoscopic image are perceived by the left eye EL and the right eye ER of the viewer. As a result, the image is perceived in a three-dimensional way by the viewer.

For example, light which is emitted from the backlight 31 and is then transmitted through the light transmissive section 71L-2 for the left eye is transmitted through the slit region 91-2 and is then incident on the left eye EL of the viewer. In addition, light which is emitted from the backlight 31 and is then transmitted through the light transmissive section 71R-2 for the right eye is transmitted through the slit region 91-2 and is then incident on the right eye ER of the viewer.

In addition, the light incident on the light shielding region 92 after being emitted from the backlight 31 and transmitted through the light transmissive section 71 is absorbed (blocked) by the light shielding region 92 so as not to be incident on the eyes of the viewer. That is, these light beams are blocked by the parallax barrier.

Moreover, in the display unit 21, light beams of respective colors of R, G, and B transmitted through each light transmissive section 71 spread with approximately the same width on the xz plane in FIG. 2 and are then incident on the left eye EL and the right eye ER of the viewer.

For example, in FIG. 2, light beams of respective colors of R, G, and B transmitted through the light transmissive section 71L-2 and light beams of respective colors of R, G, and B transmitted through the light transmissive section 71R-2 spread with approximately the same width on the xz plane and are then incident on the left eye EL and the right eye ER of the viewer.

In FIG. 2, MLR1, MLG1, and MLB1 indicate light of R color, light of G color, and light of B color transmitted through the light transmissive section 71L-2, respectively. These light beams spread with approximately the same width and are then incident on the left eye EL of the viewer. Moreover, in FIG. 2, MRR1, MRG1, and MRB1 indicate light of R color, light of G color, and light of B color transmitted through the light transmissive section 71R-2, respectively. These light beams spread with approximately the same width and are then incident on the right eye ER of the viewer.

Accordingly, even if the viewing position (left eye EL and right eye ER) of the viewer moves in the parallax direction, the light amount ratio of light beams of the respective colors of R, G, and B incident on the eyes of the viewer is approximately fixed at each position in the parallax direction. As a result, it is possible to suppress a color imbalance of a stereoscopic image.

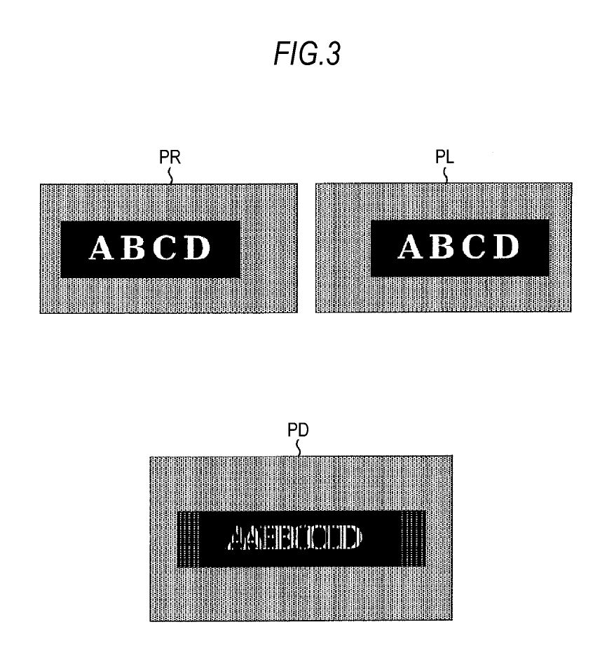

When displaying a stereoscopic image, as shown in FIG. 3, a stereoscopic image PD is generated from an image PR for the right eye and an image PL for the left eye with parallax and this stereoscopic image PD is displayed on the light modulation panel 32. In addition, in FIG. 3, the horizontal and vertical directions are directions corresponding to the x direction (parallax direction) and the y direction, respectively.

The stereoscopic image PD is an image obtained by dividing each of the images PR and PL into striped rectangular regions, which are long in the y direction, and arraying alternately in the x direction the rectangular regions obtained from the image PR and the rectangular regions obtained from the image PL, for example. Thus, when the stereoscopic image PD formed by the images PR and PL is displayed on the light modulation panel 32, the image PL for the left eye which forms the stereoscopic image PD is displayed on a pixel having the light transmissive section 71L and the image PR for the right eye which forms the stereoscopic image PD is displayed on a pixel having the light transmissive section 71R.

Next, a case of displaying a two-dimensional planar image on the stereoscopic image display device 11 will be described. In this case, the control unit 22 applies a voltage to the pixel electrode or the like on the basis of an image signal of the planar image for each pixel of the light modulation panel 32, so that the transmittance of the light transmissive section 71 is set to the transmittance corresponding to the pixel values of these pixels.

In addition, the control unit 22 controls the parallax barrier driving unit 23 such that a voltage is not applied to the electrode of the parallax barrier 33 and a parallax barrier is not formed accordingly, and also controls the display unit 21 to make light emitted from the backlight 31.

The light emitted from the backlight 31 is transmitted through the light modulation panel 32 and the parallax barrier 33 and is then incident on the left and right eyes of the viewer. That is, each pixel of the planar image is displayed on each pixel provided in the light transmissive section 71 of the light modulation panel 32.

### [Regarding the Arrangement of Filter Regions]

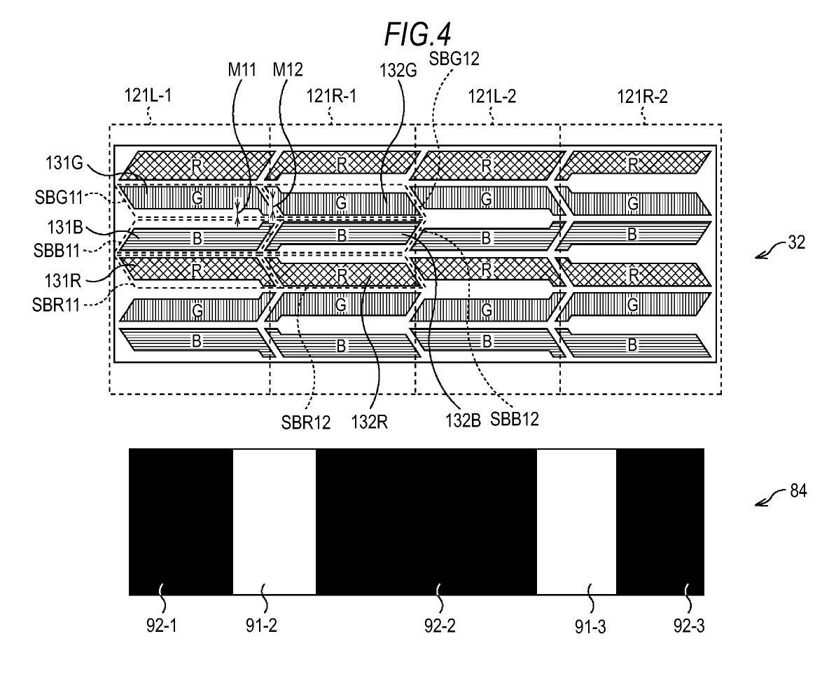

Meanwhile, a color filter which makes only a component of each color of R, G, and B, among light beams incident from the backlight 31, transmitted therethrough and incident on the parallax barrier 33 is provided in each pixel of the light modulation panel 32 as shown in FIG. 4, for example. In addition, sections in FIG. 4 corresponding to the sections in FIG. 2 are denoted by the same reference numerals, and the explanation will be appropriately omitted.

In addition, parts of the light modulation panel 32 and the switch liquid crystal layer 84 are shown in FIG. 4. In FIG. 4, the horizontal direction, the vertical direction, and the depth direction indicate x, y, and z directions, respectively. Moreover, in FIG. 4, the switch liquid crystal layer 84 is shown in a state shifted downward from the light modulation panel 32 in the drawing, for the sake of explanation.

In the example shown in FIG. 4, at the time of display of a stereoscopic image, an image for the right eye is displayed in regions 121R-1 and 121R-2 of the light modulation panel 32 and an image for the left eye is displayed in regions 121L-1 and 121L-2 of the light modulation panel 32.

In addition, hereinafter, the regions 121R-1 and 121R-2 are simply called a region 121R when it is not necessary to distinguish the regions 121R-1 and 121R-2 in particular, and the regions 121L-1 and 121L-2 are simply called a region 121L when it is not necessary to distinguish the regions 121L-1 and 121L-2 in particular.

Sub-pixels which form each pixel are provided in the regions 121R and 121L, and each sub-pixel includes a color filter, the light transmissive section 71, and the like. Each sub-pixel is a region where each color component of a pixel of a stereoscopic image is displayed. In the light modulation panel 32, the region 121R where an image for the right eye is displayed and the region 121L where an image for the left eye is displayed are arrayed alternately in the x direction.

For example, sub-pixels SBG11, SBB11, and SBR11 having color filters of respective colors of G, B, and R are provided in the region 121L-1. In addition, sub-pixels SBG12, SBB12, and SBR12 having color filters of respective colors of G, B, and R are provided in the region 121R-1.

Although each color filter is provided on the surface (hereinafter, referred to as a filter surface) of the counter substrate 63 facing the liquid crystal layer 65, a region other than the sub-pixels is a light shielding region for blocking light.

Moreover, in FIG. 4, the region of a color filter through which only the light of R color is transmitted, among color filters provided in each sub-pixel, is a region which is shaded by oblique lines and in which the letter “R” is written. In addition, among the color filters provided in each sub-pixel, the region of a color filter through which only the light of G color is transmitted is a region which is shaded by vertical lines and in which the letter “G” is written, and the region of a color filter through which only the light of B color is transmitted is a region which is shaded by horizontal lines and in which the letter “B” is written.

In addition, a filter region 131G of a G color filter through which only the light of G color is transmitted is provided in the sub-pixel SBG11. In addition, a filter region 131B of a B color filter through which only the light of B color is transmitted is provided in the sub-pixel SBB11, and a filter region 131R of an R color filter through which only the light of R color is transmitted is provided in the sub-pixel SBR11.

Similarly, filter regions 132G, 132B, and 132R of color filters of respective colors of G, B, and R are provided in the sub-pixels SBG12, SBB12, and SBR12, respectively.

In addition, not only the filter region, through which light of each color is transmitted, but also a light shielding region which blocks light is provided in each sub-pixel. For example, in the sub-pixel SBG11, a region other than the filter region 131G is a light shielding region. The light shielding region is provided below the filter region 131G in the drawing. This light shielding region is formed by covering a part of the G color filter, which serves as the filter region 131G and has the same size as the sub-pixel SBG11 in a parallelogram shape, with a light shielding member. Also in other sub-pixels, a portion other than the filter region is a light shielding region, in the same manner as in the sub-pixel SBG11.

In particular, in each sub-pixel, the y-direction length of a light shielding region in the sub-pixel is set to be approximately the same as the y-direction length of a light shielding region between sub-pixels adjacent to each other in the x direction. For example, both the y-direction length of a light shielding region, which is indicated by the arrow M11, in the sub-pixel SBG11, and the y-direction length of a light shielding region, which is indicated by the arrow M12, between the sub-pixels SBG11 and SBG12 is 12 μm. In addition, the y-direction width of a light shielding region between sub-pixels is approximately the same at each position in the x direction.

Moreover, on the filter surface of the light modulation panel 32, sub-pixels of respective colors of R, G, and B are arrayed in order in the y direction, and sub-pixels of the same colors are arrayed in the x direction. In addition, edges of the sub-pixels adjacent to each other in the x direction are approximately parallel.

Thus, sub-pixels having filter regions, through which light beams of respective colors of R, G, and B among light beams incident from the backlight 31 are transmitted, are provided in a matrix on the filter surface. Then, some light beams of respective colors transmitted through these filter regions are incident on the eyes of the viewer through the slit region 91, and the stereoscopic image is perceived by the viewer.

For example, light which is incident from the backlight 31 and is transmitted through the filter region in the region 121R-1 is incident on the right eye of the viewer through the slit region 91-2. In addition, light which is incident from the backlight 31 and is transmitted through the filter region in the region 121L-1 is incident on the left eye of the viewer through the slit region 91-2.

[Regarding the Reduction of Moiré]

Meanwhile, in order to reduce the moiré generated when a stereoscopic image is displayed, it is preferable to reduce a brightness change within a visible region where an image for the left eye or an image for the right eye, which is observed by the viewer, on the light modulation panel 32 is displayed when the viewing point of the viewer shifts in the x direction (parallax direction). In other words, it is preferable that the area of a light shielding region, which has low brightness compared with other regions, in the visible region be small regardless of the viewing position of the viewer.

In addition, the visible region is a region, in which an image perceived by one eye of the viewer is displayed without being blocked by the parallax barrier, of the region where an image for the left eye or the right eye on the filter surface is displayed. That is, assuming that all light beams from the backlight 31 are transmitted through the filter surface, a region on the filter surface, through which light incident on one of the eyes of the viewer through the slit region 91 among light beams from the backlight 31 is transmitted, is the visible region.

In order to reduce such a moiré, sub-pixels are arrayed in the light modulation panel 32 such that filter regions of respective colors of R, G, and B are necessarily present at each position of the filter surface in the x direction. For example, in FIG. 4, at least one of the filter regions 131G and 132G is necessarily present at each position in the x direction within the region including the sub-pixels SBG11 and SBG12 on the filter surface.

Accordingly, even when a light shielding region between the sub-pixels SBG11 and SBG12 is included in the visible region of the viewer, a decrease in the brightness of the visible region, that is, a decrease in the amount of light transmitted through the visible region can be reduced. As a result, the generation of a moiré can be suppressed.

In particular, since the area of the light shielding region between the sub-pixels SBG11 and SBG12 is much smaller than the area of a light shielding region between sub-pixels when the filter region of a sub-pixel is set as a rectangular region with the same area as the filter region 131G, it can be seen that the generation of a moiré is suppressed.

Moreover, in the light modulation panel 32, the width of a light shielding region in the y direction, that is, the width of a filter region in the y direction (when there are a plurality of filter regions, a total value of these widths in the y direction) is approximately the same value at each position in the x direction.

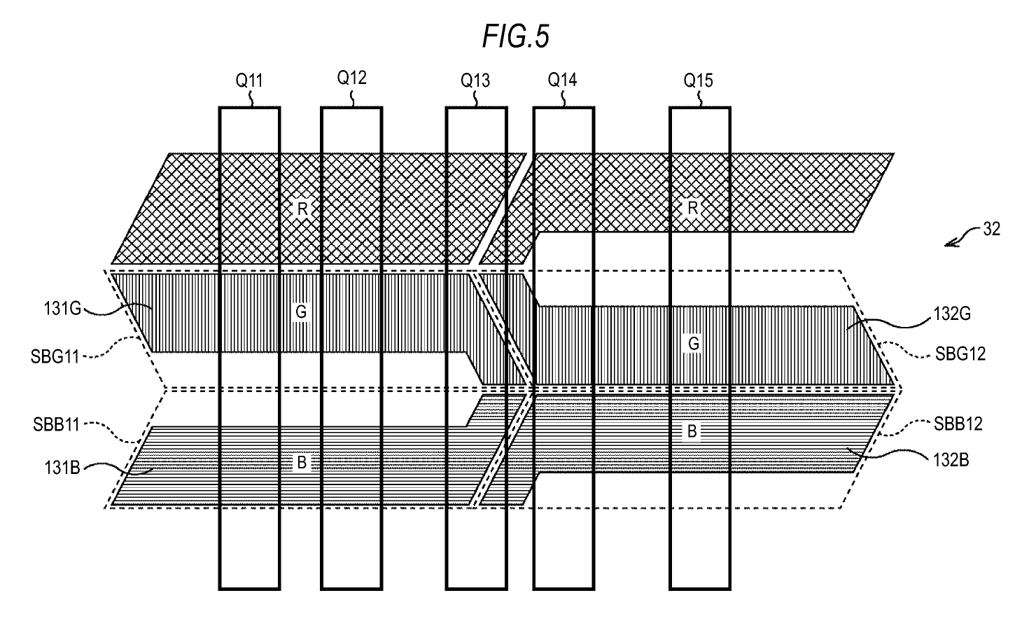

Therefore, for example, as shown in FIG. 5, the aperture ratio of the filter region of each color in the visible region, that is, the area of the filter region is approximately fixed regardless of the position of the visible region of the viewer. As a result, since a brightness change within the visible region caused by the change of the viewing position of the viewer is prevented, the generation of a moiré can be suppressed.

In addition, sections in FIG. 5 corresponding to the sections in FIG. 4 are denoted by the same reference numerals, and the explanation will be appropriately omitted. Moreover, in FIG. 5, the horizontal direction, the vertical direction, and the depth direction are assumed to be x, y, and z directions, respectively.

If the viewing position of the viewer changes in the x direction (parallax direction), the visible region on the filter surface also moves in the x direction. For example, when five different visible regions Q11 to Q15 are observed, the area of a region including the filter region 131G or 132G in each of the visible regions Q11 to Q15 is the same. In other words, the area of a light shielding region provided in each of the visible regions Q11 to Q15 is approximately the same.

Specifically, for example, the sum of the area of the filter region 131G and the area of the filter region 132G in the visible region Q13 is the same as the area of the filter region 131G in the visible region Q12.

Thus, if a filter region is formed such that the area of the filter region (light shielding region) in a visible region becomes equal for each color, a fixed amount of light is incident on the eyes of the viewer all the time. As a result, the generation of a moiré can be suppressed.

Moreover, in the light modulation panel 32, the x-direction width of the filter region of each color within the visible region and the area of the filter region are approximately fixed regardless of the position of the visible region on the filter surface. As a result, it is possible to suppress a color imbalance of a stereoscopic image according to the viewing position of the viewer. As a result, in the stereoscopic image display device 11, it is possible to maintain the appropriate color balance both when displaying a three-dimensional stereoscopic image and when displaying a two-dimensional planar image.

In addition, although the light modulation panel 32 is disposed between the backlight 31 and the parallax barrier 33 in the above explanation, the parallax barrier 33 may be disposed between the backlight 31 and the light modulation panel 32. In such a case, light emitted from the backlight 31 is incident on the light modulation panel 32 through the parallax barrier 33.

### Second Embodiment

### Regarding the Arrangement of Filter Regions

In addition, although the case where the light shielding region is provided only at one edge side of the filter region of each sub-pixel in the y direction has been described in the above, the light shielding region may also be provided at both edge sides of the filter region in the y direction.

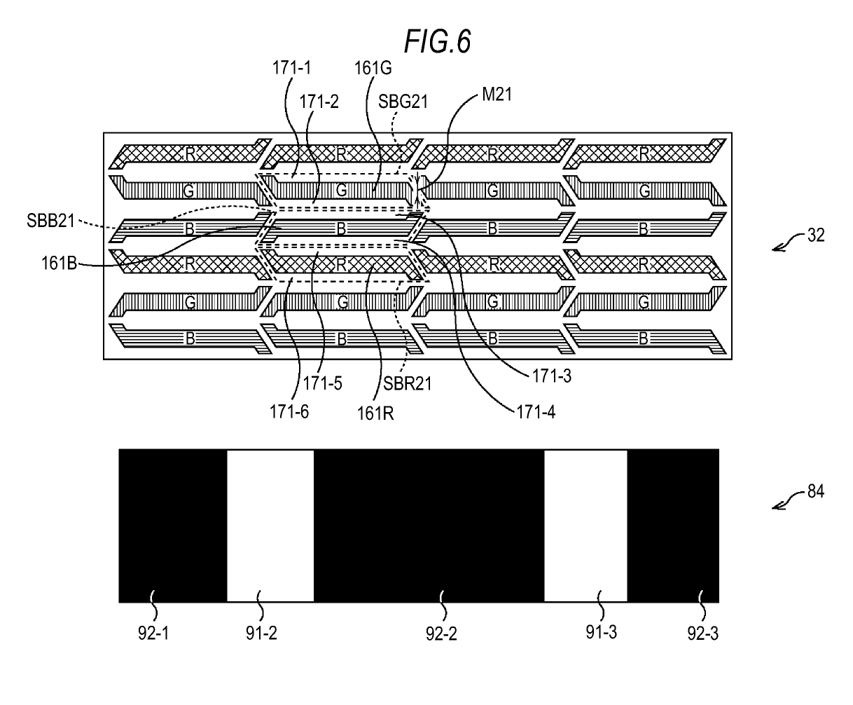

In such a case, as shown in FIG. 6, light shielding regions are provided so as to interpose a filter region therebetween in each sub-pixel of the light modulation panel 32 shown in FIG. 2, for example. In addition, sections in FIG. 6 corresponding to the sections in FIG. 2 are denoted by the same reference numerals, and the explanation will be appropriately omitted.

In addition, parts of the light modulation panel 32 and the switch liquid crystal layer 84 are shown in FIG. 6. In FIG. 6, the horizontal direction, the vertical direction, and the depth direction indicate x, y, and z directions, respectively. Moreover, in FIG. 6, the switch liquid crystal layer 84 is shown in a state shifted downward from the light modulation panel 32 in the drawing, for the sake of explanation.

Also in the example shown in FIG. 6, a region including a sub-pixel where an image for the right eye is displayed at the time of display of a stereoscopic image and a region including a sub-pixel where an image for the left eye is displayed at the time of display of a stereoscopic image are alternately arrayed in the x direction, in the same manner as in the case shown in FIG. 4. In addition, filter regions and light shielding regions of color filters of respective colors of G, B, and R are provided in each sub-pixel in these regions.

Moreover, in FIG. 6, the region of a color filter through which only the light of R color is transmitted, among color filters provided in the respective sub-pixels, is a region which is shaded by oblique lines and in which the letter “R” is written. In addition, among the color filters provided in each sub-pixel, the region of a color filter through which only the light of G color is transmitted is a region which is shaded by vertical lines and in which the letter “G” is written, and the region of a color filter through which only the light of B color is transmitted is a region which is shaded by horizontal lines and in which the letter “B” is written.

For example, sub-pixels SBG21, SBB21, and SBR21 have filter regions 161G, 161B, and 161R of color filters of respective colors of G, B, and R, respectively.

In addition, in the sub-pixel SBG21, light shielding regions 171-1 and 171-2 are provided adjacent to upper and lower portions the filter region 161G in the drawing. For example, the width of each of the light shielding regions 171-1 and 171-2 in the y direction is 6 μm. That is, in the sub-pixel SBG21, two light shielding regions whose area is half the area of the light shielding region in the sub-pixel in FIG. 4 are provided above and below the filter region 161G shown in FIG. 6.

Therefore, for example, the area of the filter region 161G of the sub-pixel SBG21 shown in FIG. 6 is the same as the area of the filter region 131G of the sub-pixel SBG11 shown in FIG. 4, and the total area of the light shielding region in the sub-pixel SBG21 is the same as the total area of the light shielding region in the sub-pixel SBG11.

Similarly, also in the sub-pixels SBB21 and SBR21, light shielding regions are provided with the same positional relationship as in the sub-pixel SBG21. That is, in the sub-pixel SBB21, light shielding regions 171-3 and 171-4 are provided adjacent to upper and lower portions of the filter region 161B in the drawing. In the sub-pixel SBR21, light shielding regions 171-5 and 171-6 are provided adjacent to upper and lower portions of the filter region 161R in the drawing.

In addition, in the example shown in FIG. 6, the sum of the y-direction lengths of the light shielding regions in each sub-pixel is approximately the same as the y-direction length of the light shielding region located between sub-pixels adjacent to each other in the x direction. For example, the y-direction length of the light shielding region indicated by the arrow M21 is 12 μm, and the sum of the y-direction widths of the light shielding regions 171-1 and 171-2 is also 12 μm.

For this reason, also in the example shown in FIG. 6, the area (aperture ratio) of the filter region of each color in the visible region and the area of the light shielding region are approximately fixed regardless of the position of the visible region of the viewer, in the same manner as in the case shown in FIG. 4. As a result, since a brightness change within the visible region caused by the change of the viewing position of the viewer is prevented, the generation of a moiré can be suppressed.

Moreover, in the example shown in FIG. 6, the y-direction width of the light shielding region in a sub-pixel is narrow, that is, the area of the light shielding region is small, compared with that in the example shown in FIG. 4. This can make it difficult to view each light shielding region with the eyes of the viewer both at the time of display of a stereoscopic image and at the time of display of a planar image.

For example, if each light shielding region in a sub-pixel is large, a light shielding region with lower brightness than a surrounding filter region may be viewed as a black mark at the time of display of a stereoscopic image or a planar image. “Each light shielding region is viewed by the viewer in this way” leads to a deterioration in the quality of the displayed image. Therefore, in the light modulation panel 32 shown in FIG. 6, the area of the entire light shielding region in each sub-pixel is the same as that in the case shown in FIG. 4, but each light shielding region is made small and these light shielding regions are disposed at separate positions so that it becomes difficult to view the light shielding regions.

In addition, in the example shown in FIG. 6, light shielding regions which form each sub-pixel, such as the light shielding region 171-1, are arrayed at shorter distances in the y direction on the filter surface, compared with the case shown in FIG. 4. As a result, it becomes more difficult for the viewer to view the light shielding regions.

### Third Embodiment

### Regarding the Arrangement of Filter Regions

Although the case where the stereoscopic image including an image for the left eye and an image for the right eye is displayed has been described in the above, the stereoscopic image display device 11 may also display a multi-viewing-point stereoscopic image including a plurality of images of three or more viewing points.

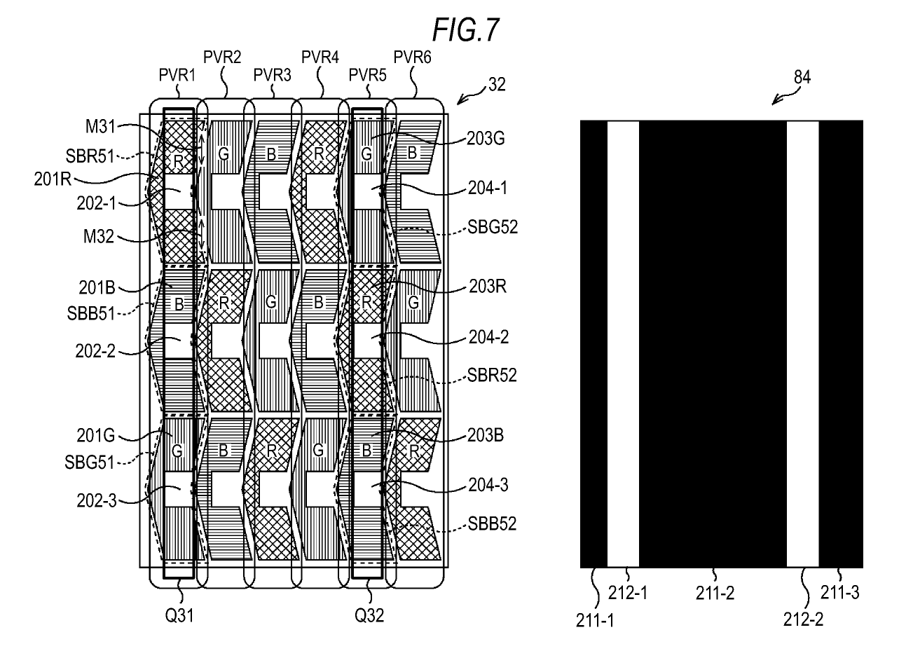

In such a case, sub-pixels having color filters of respective colors of R, G, and B are arrayed on the filter surface of the light modulation panel 32, as shown in FIG. 7, for example. In addition, sections in FIG. 7 corresponding to the sections in FIG. 2 are denoted by the same reference numerals, and the explanation will be appropriately omitted. In addition, in FIG. 7, the horizontal direction, the vertical direction, and the depth direction are assumed to be x, y, and z directions, respectively. In addition, in the example shown in FIG. 7, the switch liquid crystal layer 84, that is, the parallax barrier 33 is disposed between the light modulation panel 32 and the backlight 31.

On the filter surface of the light modulation panel 32, sub-pixels having filter regions of respective colors are arrayed in a matrix in the xy direction, as shown at the left side in FIG. 7. Moreover, in FIG. 7, parts of the light modulation panel 32 and the switch liquid crystal layer 84 are shown, and the switch liquid crystal layer 84 is shown in a state shifted rightward from the light modulation panel 32 in the drawing, for the sake of explanation.

For example, when a multi-viewing-point stereoscopic image including four different viewing points of viewing points V1 to V4 is displayed on the light modulation panel 32, an image of one viewing point V1 is displayed in regions PVR1 and PVR5 on the filter surface.

In addition, an image of the viewing point V2 is displayed in regions PVR2 and PVR6 on the filter surface, an image of the viewing point V3 is displayed in a region PVR3, and an image of the viewing point V4 is displayed in a region PVR4. That is, on the filter surface, the images of the viewing points V1 to V4 are displayed so as to be arrayed repeatedly and in order in the x direction.

Then, two images of two viewing points displayed adjacent to each other, among the viewing points V1 to V4, are perceived by the left and right eyes of the viewer, so that the stereoscopic image is viewed.

In addition, in FIG. 7, the region of an R color filter of each sub-pixel is a region which is shaded by oblique lines and in which the letter “R” is written. In addition, the region of a G color filter is a region which is shaded by vertical lines and in which the letter “G” is written, and the region of a B color filter is a region which is shaded by horizontal lines and in which the letter “B” is written.

For example, although an image of the viewing point V1 is displayed in the region PVR1, sub-pixels SBR51, SBB51, and SBG51, through which light beams of respective colors of R, B, and G are transmitted, in the region PVR1 function as one pixel at the time of display of a stereoscopic image. That is, R, B, and G components of one pixel of the image of the viewing point V1 are displayed in the sub-pixels SBR51, SBB51, and SBG51, respectively.

A filter region 201R of an R color filter through which only light of R color, among light beams incident from the backlight 31, is transmitted and a light shielding region 202-1 which blocks light incident from the backlight 31 are provided in the sub-pixel SBR51.

Similarly, a filter region 201B of a B color filter and a light shielding region 202-2 which blocks light are provided in the sub-pixel SBB51, and a filter region 201G of a G color filter and a light shielding region 202-3 which blocks light are provided in the sub-pixel SBG51.

In addition, sub-pixels SBG52, SBR52, and SBB52 of respective colors of G, R, and B are also provided in the region PVR5. In addition, a filter region 203G of G color and a light shielding region 204-1 which blocks light are provided in the sub-pixel SBG52. In addition, a filter region 203R of R color and a light shielding region 204-2 which blocks light are provided in the sub-pixel SBR52, and a filter region 203B of B color and a light shielding region 204-3 which blocks light are provided in the sub-pixel SBB52.

Here, each of the light shielding regions 202-1 to 202-3 and 204-1 to 204-3 is an approximately rectangular region and electronic members, such as TFTs which form the TFT substrate 64, are disposed at the same positions as these light shielding regions on the xy plane.

Thus, by disposing electronic members so as to overlap light shielding regions, it is possible to prevent a reduction in the transmittance of light in a filter region which is caused by electronic members.

In addition, in the case of displaying a multi-viewing-point stereoscopic image, when a voltage is applied to electrodes of the transparent plate 82 and the transparent plate 83, a parallax barrier shown at the right side in FIG. 7 is formed in the switch liquid crystal layer 84. That is, a parallax barrier including light shielding regions 211-1 to 211-3, which block light incident from the backlight 31, and slit regions 212-1 and 212-2, through which light incident from the backlight 31 is transmitted, is formed.

In addition, hereinafter, the light shielding regions 211-1 to 211-3 are also simply called a light shielding region 211 when it is not necessary to distinguish the light shielding regions 212-1 to 212-3, and the slit regions 212-1 and 212-2 are also simply called a slit region 212 when it is not necessary to distinguish the slit regions 212-1 and 212-2.

The parallax barrier shown in FIG. 7 is a striped barrier in which the light shielding region 211 and the slit region 212, each of which has a rectangular shape extending in the y direction, are alternately formed in the x direction. When such a parallax barrier is formed, for example, regions Q31 and Q32 on the filter surface become a visible region of the right eye of the viewer when the viewer observes the stereoscopic image display device 11 from a predetermined viewing position.

That is, only the image of the viewing point V1 displayed in the regions Q31 and Q32, among the images of the viewing points V1 to V4, is perceived by the right eye of the viewer. In this case, light which is incident from the backlight 31 through the slit region 212-1 and is then transmitted through each filter region in the region Q31 is incident on the right eye of the viewer. Similarly, light which is incident from the backlight 31 through the slit region 212-1 and is then transmitted through each filter region in the region Q32 is incident on the right eye of the viewer.

Moreover, in this case, light which is incident from the backlight 31 through the slit regions 212-1 and 212-2 and is then transmitted through each filter region in the regions PVR2 and PVR6 on the filter surface is incident on the left eye of the viewer. That is, the image of the viewing point V2 displayed in the regions PVR2 and PVR6 is perceived by the left eye of the viewer.

Accordingly, a stereoscopic image including the image of the viewing point V1 and the image of the viewing point V2 is perceived by the viewer. If the viewing position of the viewer moves, the visible region on the filter surface also moves. In this case, images of different viewing points are observed by the left and right eyes of the viewer.

Also when displaying the multi-viewing-point stereoscopic image, the aperture ratio (area) of the filter region of each color in a visible region is fixed regardless of the position of the visible region of the viewer.

Specifically, at each position in the x direction on the filter surface, the y-direction length of the filter region in each sub-pixel is approximately fixed. In other words, at each position in the x direction on the filter surface, the total value of the y-direction lengths of light shielding regions is approximately fixed.

For example, the y-direction length of the light shielding region 202-1 in the sub-pixel SBR51 is 12 μm. In addition, the y-direction length of each portion, which is indicated by the arrows M31 and M32, of a light shielding region between the sub-pixel SBR51 and a sub-pixel adjacent to the right side of the sub-pixel SBR51 is 6 μm. Here, the portions of the light shielding region indicated by the arrows M31 and M32 are located at the same position in the x direction, and the total value (12 (=6+6) μm) of the y-direction lengths of these portions is the same as the length of the light shielding region 202-1 in the y direction.

In FIG. 7, only one of the light shielding region in a sub-pixel and the light shielding region between sub-pixels is necessarily present at each position in the x direction. Accordingly, the area of the light shielding region is approximately fixed regardless of the position of the visible region of the viewer. As a result, since the area (aperture ratio) of the filter region of each color in the visible region is fixed regardless of the position of the visible region of the viewer, a brightness change within the visible region caused by the change of the viewing position of the viewer can be prevented to suppress the generation of a moiré.

In addition, the arrangement of sub-pixels of respective colors on the filter surface of the light modulation panel 32 is not limited to the arrangement shown in FIG. 7, and any kind of arrangement may be adopted. In addition, the parallax barrier formed in the switch liquid crystal layer 84 may have any kind of shape, such as a parallelogram shape or a stepped shape, without being limited to the stripe shape.

### Fourth Embodiment

### Regarding the Arrangement of Filter Regions

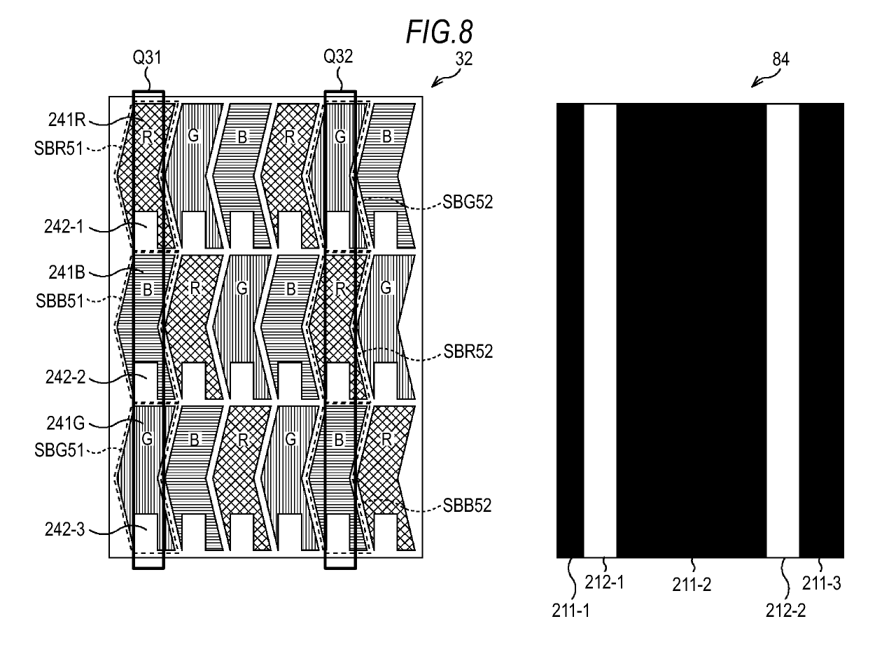

In addition, the position of a light shielding region provided in each sub-pixel may be set according to the position of an electronic member, such as a TFT provided on the TFT substrate 64 or the like, as shown in FIG. 8, for example.

In addition, sections in FIG. 8 corresponding to the sections in FIG. 7 are denoted by the same reference numerals, and the explanation will be appropriately omitted. In addition, in FIG. 8, the horizontal direction, the vertical direction, and the depth direction are assumed to be x, y, and z directions, respectively. In addition, in FIG. 8, the region of an R color filter of each sub-pixel is a region which is shaded by oblique lines and in which the letter “R” is written. In addition, the region of a G color filter is a region which is shaded by vertical lines and in which the letter “G” is written, and the region of a B color filter is a region which is shaded by horizontal lines and in which the letter “B” is written.

Each sub-pixel in FIG. 8 is the same as the sub-pixel in FIG. 7 except for only the position of a light shielding region in a sub-pixel. In addition, the arrangement of sub-pixels of respective colors on the filter surface in FIG. 8 is also the same as the arrangement of sub-pixels of respective colors in FIG. 7.

That is, a light shielding region is disposed at the lower left side of each sub-pixel in FIG. 8, while a light shielding region is disposed at the right side of each sub-pixel in FIG. 7.

For example, in FIG. 8, a filter region 241R of R color and a light shielding region 242-1 are provided in the sub-pixel SBR51, and the light shielding region 242-1 is located at the lower left side of the sub-pixel SBR51 in the drawing.

Similarly, a filter region 241B of B color and a light shielding region 242-2 are provided in the sub-pixel SBB51, and the light shielding region 242-2 is located at the lower left side of the sub-pixel SBB51 in the drawing. In addition, a filter region 241G of G color and a light shielding region 242-3 are provided in the sub-pixel SBG51, and the light shielding region 242-3 is located at the lower left side of the sub-pixel SBG51 in the drawing.

In addition, electronic members, such as TFTs provided on the TFT substrate 64 which forms the light modulation panel 32, are disposed so as to overlap the light shielding regions 242-1 to 242-3.

Also in the example shown in FIG. 8, the total value of the y-direction lengths of light shielding regions at each position in the x direction on the filter surface is approximately fixed regardless of the position of the visible region of the viewer.

That is, since only one of the light shielding region in a sub-pixel and the light shielding region between sub-pixels is necessarily present at each position in the x direction, the area of the light shielding region in the visible region is approximately fixed regardless of the position of the visible region of the viewer. Therefore, since the area (aperture ratio) of the filter region of each color in the visible region is fixed regardless of the position of the visible region of the viewer, a brightness change within the visible region caused by the change of the viewing position of the viewer can be prevented to suppress the generation of a moiré.

In addition, although the case where a stereoscopic image is displayed using the parallax barrier method has been described in the above, any method, such as a lenticular lens method may be used to display the stereoscopic image. For example, when displaying a stereoscopic image using a lenticular lens method, images of the respective viewing points are separated by the lenticular lens provided in the display unit 21.

In addition, although the configuration in which a counter electrode is provided in the light modulation panel 32 has been described as an example in the above, the light modulation panel 32 may have a configuration of changing the transmittance of light of each pixel using an in-plane switching method in which the counter electrode is not provided. In addition, also in the case where the counter electrode is provided in the light modulation panel 32, the transmittance of each pixel may be changed using any method, such as a twisted nematic method, a vertical alignment method, and a field effect birefringence method.

By disposing the parallax barrier 33 at the viewer side rather than the light modulation panel 32 as shown in FIG. 2, the present disclosure may also be applied to an organic EL (ElectroLuminescence) method or display of a stereoscopic image in plasma display.

In addition, although the case where the present disclosure is applied to the stereoscopic image display device that displays a stereoscopic image has been described as an example in the above, the present disclosure may also be applied to display devices, such as a multi-display. In the multi-display, when a display screen is viewed simultaneously from different viewing positions, such as a driver's seat and a passenger seat, image display is performed so that different two-dimensional images are observed from the respective viewing positions.

In addition, embodiments of the present disclosure are not limited to the above-described embodiments, and various modifications may also be made without departing from the spirit and scope of the present disclosure.

The present disclosure contains subject matter related to that disclosed in Japanese Priority Patent Application JP 2011-056993 filed in the Japan Patent Office on Mar. 15, 2011, the entire contents of which are hereby incorporated by reference.

What is claimed is:

1. A display device comprising:
a display unit having a region which emits color light for displaying a stereoscopic image including images of a plurality of viewing points; and
a separation unit that separates optically the images of the respective viewing points from each other so that the images of different viewing points are observed by different eyes of a viewer,
wherein in a visible region on the display unit in which the image of a predetermined viewing point observed by the viewer is displayed, the region which emits the color light is present at each position of the stereoscopic image in a parallax direction regardless of a viewing position of the viewer who observes the stereoscopic image.

2. The display device according to claim 1,
wherein the display unit has not only the region which emits the color light but also a light shielding region which blocks light, and
at each position in the parallax direction in the visible region, the total width of the light shielding region in a vertical direction approximately perpendicular to the parallax direction is an approximately fixed value.

3. The display device according to claim 1,
wherein the display unit has not only the region which emits the color light but also a light shielding region which blocks light, and
the area of the light shielding region in the visible region is an approximately fixed value regardless of a viewing position of the viewer who observes the stereoscopic image.

4. The display device according to claim 1,
wherein the display unit has not only the region which emits the color light but also a light shielding region which blocks light,
the region which emits the color light is formed by providing a light shielding section, which becomes the light shielding region, in a part of a filter through which the color light is transmitted, and
the light shielding section is provided at both edge sides of the filter in a vertical direction approximately perpendicular to the parallax direction.

5. A display device comprising:
a display unit having a region which emits color light including a plurality of viewing point images; and
a separation unit that separates optically the viewing point images from each other,
wherein the display unit has not only the region which emits the color light but also a light shielding region which blocks light, and
the total width of the light shielding region in a vertical direction approximately perpendicular to a direction in which the viewing point images are aligned is an approximately fixed value.
